(19) United States
(12) Patent Application Publication
(10) Pub. No.: US 2011/0255174 A1
(43) Pub. Date: Oct. 20, 2011

(54) Display Device with an Optical Combiner Corrected for Chromatic Aberrations

(75) Inventor: Laurent Bignolles, Bordeaux (FR)

(73) Assignee: THALES, Neuilly-sur-Seine (FR)

(21) Appl. No.: 13/088,241

(22) Filed: Apr. 15, 2011

(30) Foreign Application Priority Data
Apr. 16, 2010 (FR) 10 01631

(51) Int. Cl. G02B 27/01

(52) U.S. Cl. 359/632

(57) ABSTRACT

A head-up display or helmet-mounted display device includes at least one image source configured to emit a first image in at least two different spectral bands. A relay optics includes at least one first optical element for reflecting the two spectral bands and a semi-reflecting second optical element. The relay optics and the semi-reflecting second optical element are arranged so as to give, from the first image emitted by the image source, a second image at infinity. In the device, when the image source is a dichromatic source, the reflecting first optical element comprises a thin plate, the first side of which comprises a first treatment reflecting the first spectral band and transmitting the second spectral band, and the second side of which comprises a second treatment reflecting at least the second spectral band, the thickness of said plate being such that the axial chromatic aberration, generated by the other optical elements composing the relay optics, existing between the two spectral bands, is substantially cancelled.

### CROSS-REFERENCE TO RELATED APPLICATION

This application claims priority to foreign French patent application No. FR 1001631, filed on Apr. 16, 2010, the disclosure of which is incorporated by reference in its entirety.

### FIELD OF THE INVENTION

The field of the invention is that of optical display devices called optical combiners, i.e. comprising an optical element allowing an image to be superposed on the exterior landscape seen by a user. The image is emitted by an image source and this image is generally collimated, i.e. sent to infinity so as to superpose on the exterior perfectly without causing visual accommodation difficulties for the user.

The fields of head-up display (HUD) and helmet-mounted display (HMD) devices are mainly concerned. These devices are mainly used in aeronautical applications but, of course, any application requiring the display of visual information in the field of vision of a user is also relevant to the field of the invention.

### BACKGROUND

Integration constraints on HUDs in aircraft cockpits and in HMDs on the head of users lead to often complicated optical architectures using decentred and/or aspheric lenses. Optical architectures are particularly complicated in HUDs using what is called an off-axis combiner. Geometric aberrations in these optical systems are then very substantial and very difficult to correct.

Currently, the image displayed is most often monochromatic and the spectrum of the image is very narrow. Thus, chromatic aberrations in these optical architectures are inevitably slight and are not corrected so as to avoid introducing additional constraints on the correction of the geometric aberrations. FIGS. 1 and 2 show views in cross section of HUD architectures, the first showing an architecture where the display is integrated into the ceiling of the cockpit, the second showing an architecture where the display is integrated into the glareshield. The position of the head H of the user has been shown in these two figures. These two architectures comprise an image source 1, a relay optics 10 and a combiner 20. In the two cases, it may be seen that some of the lenses 11 that form the optical architecture are highly prismatic and off axis. The propagation of the light rays emitted from the centre of the image source 1 is shown by the fine lines in these and the following figures.

However, new generations of dichromatic or trichromatic displays are currently being studied and developed. One of the constraints on the image sources used in head-up displays is that they must deliver a very high brightness so as to be compatible with sunlight. There are currently light-emitting diodes powerful enough to allow dichromatic and trichromatic high-brightness image sources to be produced. It is therefore necessary to provide a projection optic compatible with a dichromatic or trichromatic source, i.e. an optic corrected for chromatic aberration in a spectrum comprising several spectral bands.

The refractive index of lenses and prisms varies with wavelength. The image of a luminous point through one or more optical components therefore depends on the wavelength of the emitted light. This phenomenon is called chromatic aberration. By way of example, FIG. 3 shows the chromatic aberration introduced by a lens L to a luminous point A emitting at two wavelengths λ₁ and λ₂. The image of the point A at the wavelength λ₁ is the point A′₁ and the image of the point A at the wavelength λ₂ is the point A′₂. Chromatic aberration is generally separated into axial and lateral chromatic aberration. In FIG. 1, the axial chromatic aberration corresponds to the distance D_{CA} separating the points A′₁ and A′₂ along the optical axis and the lateral chromatic aberration corresponds to the distance D_{CL} separating the points A′₁ and A′₂ in the image plane.

In the case of optical display devices with an optical combiner, lateral chromatic aberration may be corrected in the image source. All that is required is for the images generated in the image source in the various colours to be offset by the right amount necessary to compensate for the lateral chromatic aberration. In contrast, correction of axial chromatic aberration is much harder to carry out. This is because, as shown above, geometric aberrations are already difficult to correct. However, the architectures employed to correct geometric aberrations comprise highly prismatic components that are inevitably extremely chromatic. Correcting chromatic aberrations in this type of optical architecture can be extremely difficult on account of constraints on bulk and image quality.

Dichromatic head-up displays exist in the automotive field. The optics used in such systems mainly comprise mirrors, which are by nature achromatic. Such devices are not easily transposed to aeronautical applications. This is because the constraints on bulk in a cockpit or helmet are very different to those of a car dashboard. In addition, such systems have rather small fields of vision, of about a few degrees, much lower than the visual fields required for head-up displays or helmet-mounted displays, often of between 30° and 45°. Finally, the same optical quality is not required of a device for a vehicle as for an instrument fitted on an aircraft where the correlation between the information presented and the exterior landscape must be excellent.

In the HUD field, U.S. Pat. No. 5,710,668 of Flight Dynamics describes a display comprising a combiner allowing the axial chromatic aberration of an optical architecture of an HUD to be corrected. The solution provided consists in producing a combiner comprising several reflecting surfaces. Each surface comprises a treatment reflecting one particular spectral band and having a suitable form so that the various images reflected by the various surfaces coincide. This solution effectively allows the axial chromatic aberration to be corrected. However, it has several major drawbacks. When the device is a head-up display, producing a large component comprising several curved surfaces having different, perfectly separated dichroic treatments is complicated. This complexity is further increased when the combiner comprises several plates as shown in FIG. 4 where the combiner 20 is initially composed of two plates 21 and 22 with plane and parallel sides. When the device is a helmet-mounted display, if the combiner must be integrated into the visor, this technical solution poses extremely complicated production problems on account of the combiner being placed in the field of vision of the user, having to stay a reasonable weight, having to conform to the shape of the visor, etc.

### SUMMARY OF THE INVENTION

The device according to the invention does not have these drawbacks. Most optical architectures for displays comprise a combiner and a relay optics which forms, from the image emitted by the image source, an intermediate image which is then collimated by the combiner. Most often, the relay optics comprises a folding mirror allowing the relay optics to be housed in the specified bulk. Thus, the prism in the relay optics in FIG. 1 comprises a reflecting plane surface and the relay optics in FIG. 2 also comprises a folding mirror. The device according to the invention consists in modifying this mirror so as to make the optical assembly achromatic.

More precisely, the subject of the invention is a display device comprising at least one image source configured to emit a first image in at least two different spectral bands, a relay optics comprising at least one first optical element for reflecting the two spectral bands and a semi-reflecting second optical element, the relay optics and the semi-reflecting second optical element being arranged so as to give, from the first image emitted by the image source, a second image at infinity, characterized in that the reflecting first optical element comprises a thin plate, the first side of said thin plate comprising a first treatment reflecting the first spectral band and transmitting the second spectral band, the second side of said thin plate comprising a second treatment reflecting at least the second spectral band, the thickness of said plate being such that the axial chromatic aberration, generated by the other optical elements composing the relay optics, existing between the two spectral bands, is substantially cancelled.

Advantageously, the device comprises an image source configured to emit a first image in a plurality of different spectral bands and the reflecting first optical element comprises a succession of thin plates bonded together, each plate comprising a treatment reflecting one and only one spectral band and transmitting the other spectral bands, the thicknesses of the plates being such that the axial chromatic aberration, generated by the other optical elements composing the relay optics, existing between the plurality of spectral bands, is substantially cancelled.

Advantageously, the plate or plates have plane and parallel sides, at least one of the plates being made of a medium that absorbs at least one of the spectral emission bands.

Advantageously, the reflecting first optical element is a plane mirror or a prism.

Advantageously, each colour dot of the image is composed from elementary colour pixels emitting in a given spectral band, the various pixels of each dot being offset so as to compensate for the lateral chromatic aberration generated by the relay optics.

Preferably, the device is:

a head-up display fixedly placed in a cockpit of an aircraft, the semi-reflecting second optical element being a combiner arranged so as to superpose the second image at infinity on the exterior landscape; or

a helmet-mounted display, the semi-reflecting second optical element being a combiner arranged so as to superpose the second image at infinity on the exterior landscape, the second optical element being integrated into a helmet visor.

### BRIEF DESCRIPTION OF THE DRAWINGS

The invention will be better understood and other advantages will become clear on reading the following non-limiting description and by virtue of the appended figures among which:

FIGS. 1 and 2 show two head-up display architectures according to the prior art;

FIG. 3 illustrates the chromatic aberration caused by a refracting optical component;

FIG. 4 shows a double-mirror head-up display architecture according to the prior art;

FIG. 5 shows how axial chromatic aberration is in principle corrected by a dichromatic plate according to the invention;

FIG. 6 shows how axial and lateral chromatic aberration is in principle corrected by a dichromatic plate and an image source according to the invention; and

FIGS. 7 and 8 show two head-up display architectures according to the invention.

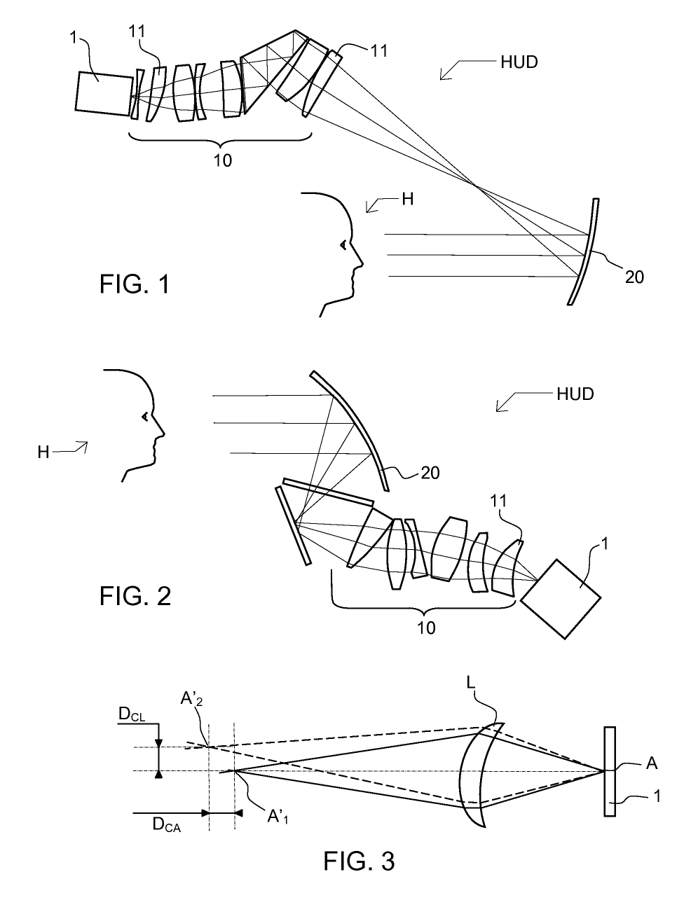

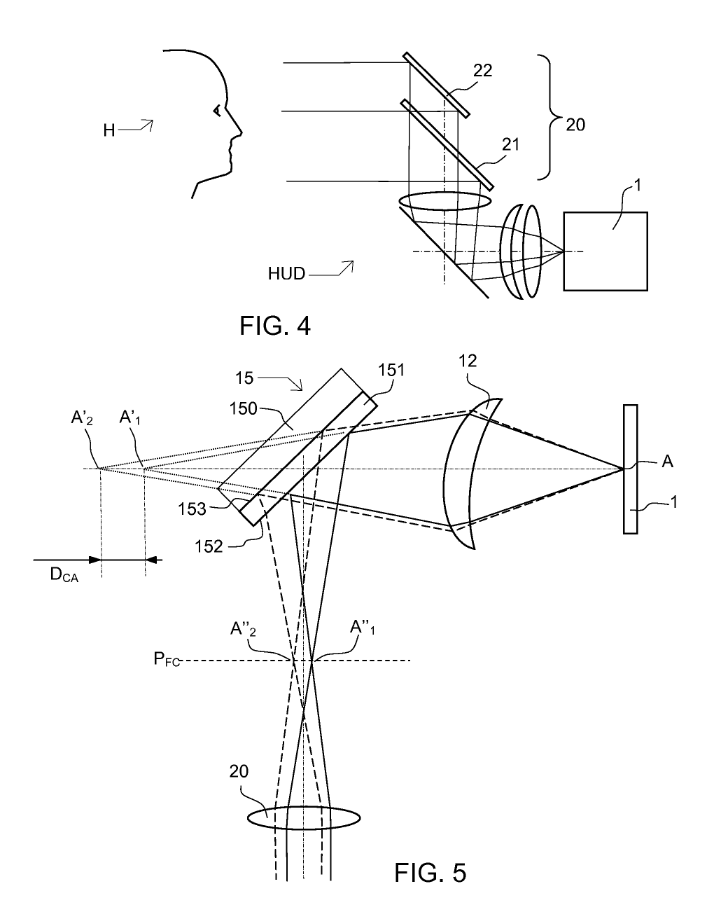

### DETAILED DESCRIPTION

By way of non-limiting example, FIG. 5 shows how axial chromatic aberration is in principle corrected according to the invention in the case of a display device emitting two different spectral bands. The display device shown in this figure comprises an image source 1, a relay optics 12 and an optical combiner shown as an achromatic lens 20.

The image source 1 may emit in two different, narrow spectral bands emitted around two wavelengths λ₁ and λ₂. The first band may be centred in the green around a wavelength λ₁ lying between 500 and 550 nanometres, the second band may be centred in the red around a wavelength λ₂ lying between 600 and 650 nanometres. In FIG. 5 the light emitted by the point A, belonging to the image source, is represented by continuous lines when the light belongs to the first band centred on the wavelength λ₁ and by dashed lines when the light belongs to the second spectral band centred on the wavelength λ₂.

The relay optics comprises a group of lenses 12 and an off axis reflecting element 15. inclined to the optical axis of this group of lenses.

In FIG. 5, for the sake of clarity, the group of lenses 12 is reduced to a single off-axis lens. It may in fact be much more complex. This group of lenses is generally chromatic. Thus, as has been seen, the image of the point A at the wavelength λ₁ is the point A′₁ and the image of the point A at the wavelength λ₂ is the point A′₂. The distance separating the points A′₁ and A′₂ along the optical axis corresponds to the axial chromatic aberration D_{CA} of the group of lenses.

The reflecting element 15 comprises a substrate 150 and a thin plate 151 comprising two plane and parallel sides 152 and 153. The first side 152 comprises a first treatment reflecting the first spectral band and transmitting the second spectral band, the second side 153 comprises a second treatment reflecting the second spectral band. The reflecting element 15 gives, by reflection from the first side, an image A″₁ of the point A′₁ and gives, by reflection from the second side, an image A″₂ of the point A′₂. It is easy to see that, for a given axial chromatic aberration, and knowing the inclination and the refractive index of the thin plate, there is always a plate thickness such that the images A″₁ and A″₂ are both in the focal plane P_{FC} of the combiner 20. Consequently, the axial chromatic aberration is corrected by introducing the reflecting element 15 according to the invention. For production purposes, it is preferable for the reflecting element to be plane. It is also possible to produce an optical element for correcting chromatic aberration having curved surfaces, the curvature of each surface possibly being slightly different. Production is necessarily a little more complicated. The thin plate 151 has a small thickness lying between a few tenths of a millimetre and a few millimetres. Consequently, in most applications, it is bonded or produced on a glass substrate 150 so that the element 15 is robust and easy to handle. This substrate may have an optical function.

It is clear that the splitter treatment of the first side must be as perfect as possible in order to prevent ghost images. Conventionally, the spectral bands are quite separated from each other, the first possibly being in the “green” and the second in the “red”, thereby making production of the splitter treatment easier. To prevent any reflection of the first spectral band by the second side, it is advantageous to make the plate of a material that absorbs the first spectral band.

Of course, this solution is also applicable when the image source emits in three different spectral bands, even in a plurality of spectral bands. The reflecting optical element then comprises a succession of thin plates bonded to one another, each plate comprising a treatment reflecting one and only one spectral band and transmitting the other spectral bands, the thicknesses of the plates being such that the axial chromatic aberration, generated by the other optical elements composing the relay optics, between the plurality of spectral bands, is substantially cancelled.

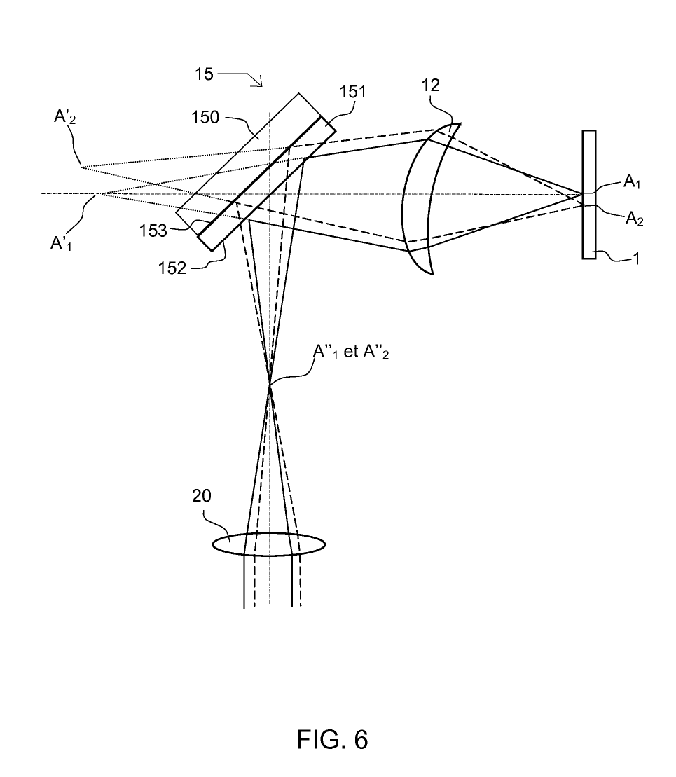

This solution works well as long as the images generated in each of the spectral bands are separated, when, for example, it is desired to generate red alarms on a background of green images. If the pixels comprise both a first component in the first spectral band and a second component in the second spectral band, then it is necessary to also correct the lateral chromatic aberration. This is the case, for example, for a dichromatic display in which it is desired to generate “red” images belonging to a first spectral band, “green” images belonging to a second spectral band and “yellow” images belonging to both spectral bands. This correction is easily made in the image source 1, the various components of each colour dot being separated at emission so as to correct the lateral chromatic aberration of the relay optics and the reflecting element. This configuration is illustrated in FIG. 6. The point A comprises two components A₁ and A₂ offset at emission in the image source. The relay optics 12 gives from these points A₁ and A₂ two pixels A′₁ and A′₂. The reflecting element 15 gives by reflection from the first side 152 of the plate 151 an image A″₁ of the point A′₁ and gives by reflection from the second side 153 an image A″₂ of the point A′₂. These two images A″₁ and A″₂ coincide if the offset between the initial points A₁ and A₂ was so calculated.

The device according to the invention is applicable to head-up display (HUD) optics comprising at least one folding mirror, i.e. in particular:

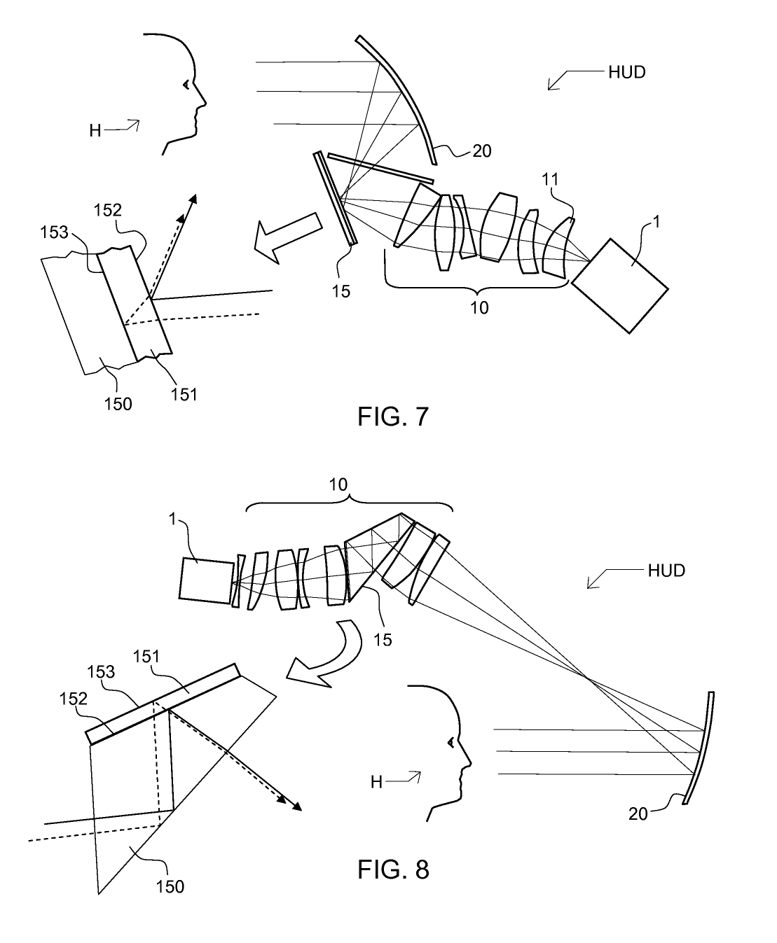

to HUDs intended for installation in an instrument panel in a fighter or trainer aircraft. By way of example, FIG. 7 shows an HUD of this type. In this example, the initial reflecting mirror 15 comprises a plate 151 according to the invention bonded to a plane substrate 150 so as to correct the axial chromatic aberration of the relay optics 10. This plate 151 comprises two reflecting sides 152 and 153; and

to HUDs located above the head of the pilot, comprising, for reasons of bulk, one or more folding mirrors. By way of example, FIG. 8 shows an HUD of this type. In this example, the initial reflecting prism 15 comprises, on one of its sides, a plate 151 according to the invention for correcting the axial chromatic aberration of the relay optics 10. This plate 151 comprises two reflecting sides 152 and 153.

The invention is also applicable to optical architectures for helmet-mounted displays. In this type of small-dimension architecture housed inside a helmet it is rare for the optical architecture to not comprise at least one folding mirror.

One of the main advantages of the device according to the invention is that it allows an optic initially provided for a monochromatic operation, i.e. with no correction of chromatic aberrations, to be very easily transformed into an optic corrected for chromatic aberration, by simply replacing an optical component, in this case a mirror or a prism, without having to fit a new optical assembly.

A second advantage is that this element is in most cases a plate with plane and parallel sides and its production presents no particular difficulty.

1. A display device comprising:
at least one image source configured to emit a first image in at least two different spectral bands, and
a relay optics comprising at least one first optical element for reflecting the two spectral bands and a semi-reflecting second optical element, the relay optics and the semi-reflecting second optical element being arranged so as to give, from the first image emitted by the image source, a second image at infinity,
wherein the reflecting first optical element comprises a thin plate, the first side of said thin plate comprising a first treatment reflecting the first spectral band and transmitting the second spectral band, the second side of said thin plate comprising a second treatment reflecting at least the second spectral band, the thickness of said plate being such that the axial chromatic aberration, generated by the other optical elements composing the relay optics, existing between the two spectral bands, is substantially cancelled.

2. The display device according to claim 1, wherein the device further comprises an image source configured to emit a first image in a plurality of different spectral bands and wherein the reflecting first optical element further comprises a succession of thin plates bonded together, each plate comprising a treatment reflecting one and only one spectral band and transmitting the other spectral bands, the thicknesses of the plates being such that the axial chromatic aberration, generated by the other optical elements composing the relay optics, existing between the plurality of spectral bands, is substantially cancelled.

3. The display device according to claim 1, wherein the plate has plane and parallel sides.

4. The display device according to claim 1, wherein the plate is made of a medium that absorbs at least one of the spectral emission bands.

5. The display device according to claim 1, wherein the reflecting first optical element is a plane mirror.

6. The display device according to claim 1, wherein the reflecting first optical element is a prism.

7. The display device according to claim 1, wherein each colour dot of the image is composed from elementary colour pixels emitting in a given spectral band, the various pixels of each dot being offset so as to compensate for the lateral chromatic aberration generated by the relay optics.

8. The display device according to claim 1, wherein the device is a head-up display fixedly placed in a cockpit of an aircraft, the semi-reflecting second optical element being a combiner arranged so as to superpose the second image at infinity on the exterior landscape.

9. The display device according to claim 1, wherein the device is a helmet-mounted display, the semi-reflecting second optical element being a combiner arranged so as to superpose the second image at infinity on the exterior landscape.

10. The display device according to claim 9, wherein the second optical element is integrated into a helmet visor.

11. The display device according to claim 2, wherein the plates have plane and parallel sides.

12. The display device according to claim 2, wherein at least one of the plates is made of a medium that absorbs at least one of the spectral emission bands.

13. The display device according to claim 2, wherein the reflecting first optical element is a plane mirror.

14. The display device according to claim 2, wherein the reflecting first optical element is a prism.

15. The display device according to claim 2, wherein each colour dot of the image is composed from elementary colour pixels emitting in a given spectral band, the various pixels of each dot being offset so as to compensate for the lateral chromatic aberration generated by the relay optics.

16. The display device according to claim 2, wherein the device is a head-up display fixedly placed in a cockpit of an aircraft, the semi-reflecting second optical element being a combiner arranged so as to superpose the second image at infinity on the exterior landscape.

17. The display device according to claim 2, wherein the device is a helmet-mounted display, the semi-reflecting second optical element being a combiner arranged so as to superpose the second image at infinity on the exterior landscape.

18. The display device according to claim 17, wherein the second optical element is integrated into a helmet visor.
